(19) United States
(12) Patent Application Publication
(10) Pub. No.: US 2013/0283275 A1
(43) Pub. Date: Oct. 24, 2013

(54) MOBILE TERMINAL AND CONTROL METHOD THEREOF

(71) Applicant: LG ELECTRONICS INC., Seoul (KR)

(72) Inventors: Taeyoung Kim, Seoul (KR); Yoomee Song, Seoul (KR); Sujung Kim, Seoul (KR); Jongkeun Youn, Seoul (KR); Hyolin Kim, Seoul (KR); Daeho Moon, Seoul (KR); Dohyun Lim, Seoul (KR)

(73) Assignee: LG Electronics Inc., Seoul (KR)

(21) Appl. No.: 13/868,817

(22) Filed: Apr. 23, 2013

(30) Foreign Application Priority Data
Apr. 24, 2012 (KR) 10-2012-0042834

(51) Int. Cl. G06F 9/445

(52) U.S. Cl. CPC G06F 9/445
USPC 718/100

(57) ABSTRACT

A mobile terminal according to one embodiment includes a display unit configured to output a setting screen for setting an enabled or disabled state of an application, and a controller configured to convert the state of the application from the enabled state into the disabled state to prohibit a user's access to the application based on a control command for disabling the application, the control command being received through the setting screen, and configured to control the display unit to output a pop-up window for changing the disabled state of the application, in response to selection of a function executable by the disabled application.

### CROSS-REFERENCE TO RELATED APPLICATION

Pursuant to 35 U.S.C. §119(a), this application claims the benefit of earlier filing date and right of priority to Korean Application No. 10-2012-0042834, filed on Apr. 24, 2012, the contents of which is incorporated by reference herein in its entirety.

### BACKGROUND OF THE INVENTION

1. Field of the Invention

This specification relates to a mobile terminal with installed applications, and a control method thereof.

2. Background of the Invention

Terminals may be divided into mobile/portable terminals and stationary terminals according to their mobility. Mobile terminals (mobile device, portable device, portable terminal) can be easily carried and have one or more of functions such as supporting voice and video telephony calls, inputting and/or outputting information, storing data and the like.

As it becomes multifunctional, the portable terminal can be allowed to capture still images or moving images, play music or video files, play games, receive broadcast and the like, so as to be implemented as a multimedia player.

Various new attempts have been made for the multimedia devices by hardware or software in order to implement such complicated functions.

The mobile terminal may have various applications installed by a terminal operator, a communication operator or a user. Among those installed applications, applications which are not frequently used by the user may cause unnecessary consumption of a memory.

### SUMMARY OF THE INVENTION

Therefore, an aspect of the detailed description is to provide a mobile terminal capable of restricting an operation of an application which is not frequently used or prohibited from being uninstalled, and a control method thereof.

To achieve these and other advantages and in accordance with the purpose of this specification, as embodied and broadly described herein, there is provided a mobile terminal including a display unit configured to output a setting screen for setting an enabled or disabled state of an application, and a controller configured to convert the state of the application from the enabled state into the disabled state to prohibit a user's access to the application based on a control command for disabling the application, the control command being received through the setting screen, and configured to control the display unit to output a pop-up window for changing the disabled state of the application, in response to selection of a function executable by the disabled application.

In accordance with one aspect, the controller may control the display unit to output the setting screen thereon based on a user selection using the pop-up window, and convert the disabled state of the application into the enabled state in response to the control command, which is received through the setting screen for activating the disabled application.

In accordance with one aspect, the controller may execute the function using the application converted into the enabled state as the disabled application is converted into the enabled state.

In accordance with one aspect, the pop-up window may display notification information notifying that the disabled application has been enabled, and guide information for receiving a control command for enabling the disabled application.

In accordance with one aspect, the controller may execute the function using another application without outputting the pop-up window when there is another application which is capable of substituting for the disabled application allowing for execution of the function.

In accordance with one aspect, the controller may control the display unit to output a select window for selecting whether or not to enable the disabled application and whether or not to use another application, and also execute the function using the other application when the use of the other application is selected through the select window.

In accordance with one aspect, the controller may output a select window for allowing a user to select one of a plurality of applications, without outputting the pop-up window, when there is a plurality of applications for substituting for the disabled application.

In accordance with one aspect, the select window may include a plurality of items corresponding to the plurality of applications, respectively, and an item corresponding to the disabled application.

In accordance with one aspect, the controller may display the item corresponding to the disabled application to be distinguishable from the plurality of items respectively corresponding to the plurality of applications, for allowing identification of disabled state information relating to the disabled application.

In accordance with one aspect, the controller may minimize a size of a memory allocated for running the application when the state of the application is converted from the enabled state into the disabled state.

In accordance with one aspect, the controller may change a display state of an icon corresponding to the application converted into the disabled state to be displayable on the display unit.

In accordance with one aspect, the controller may control the display unit such that the icon corresponding to the application converted into the disabled state cannot be displayed on a home screen page.

In accordance with one aspect, the setting screen may display a plurality of items corresponding to a plurality of pre-installed applications, respectively. Here, one area of an item corresponding to an application converted into the disabled state, among the plurality of applications, may be used to display state information relating to the application converted into the disabled state.

In accordance with one aspect, the controller may maintain the arrangement sequence of the plurality of applications, irrespective of at least one of the plurality of applications being converted into the disabled state.

In accordance with one aspect, the selection of the function executable by the disabled application may be allowed by an application different from the disabled application.

In accordance with one aspect, the controller may continuously display a function icon corresponding to the function executable by the disabled application on an execution screen of another application, irrespective of the disabled state of the disabled application, when the function executable by the disabled application is cooperative with another application.

In accordance with one aspect, the controller may display the function icon in a different manner of displaying the function icon displayed when the disabled application is in the enabled state, such that a user can identify the disabled state of the disabled application.

To achieve these and other advantages and in accordance with the purpose of this specification, as embodied and broadly described herein, there is provided a control method for a mobile terminal including, outputting a setting screen for changing an enabled state of an application, converting the state of the application from the enabled state into a disabled state to prohibit a user's access to the application based on a control command for disabling the application, the control command being received through the setting screen, and outputting a pop-up window for changing the disabled state of the application, in response to selection of a function executable by the disabled application.

In accordance with one aspect, the function may be executed through the application converted into the enabled state as the disabled application is converted into the enabled state.

In accordance with one aspect, the function may be executed using another application, without outputting the pop-up window, when there is another application for substituting for the disabled application allowing for execution of the function.

Further scope of applicability of the present application will become more apparent from the detailed description given hereinafter. However, it should be understood that the detailed description and specific examples, while indicating preferred embodiments of the invention, are given by way of illustration only, because various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate embodiments and together with the description serve to explain the principles of the invention.

In the drawings:

FIG. 1 is a block diagram of a mobile terminal in accordance with one embodiment of the present disclosure;

FIGS. 2A and 2B are front and rear perspective views of one example of the mobile terminal;

FIGS. 3 to 6 are conceptual views showing a method for changing an enabled state of an application in a mobile terminal in accordance with one embodiment;

FIG. 7 is a flowchart showing a control method for activating a disabled application in a mobile terminal in accordance with one embodiment;

FIGS. 8 to 9 are conceptual views showing the control method shown in FIG. 7;

FIGS. 10 to 11 are conceptual views showing an example that there is an application for substituting for a disabled application in a mobile terminal in accordance with one embodiment;

FIGS. 12 to 13 are conceptual views showing an example that there are a plurality of applications for substituting for a disabled application in a mobile terminal in accordance with one embodiment;

FIGS. 14 to 15 are conceptual views showing a method for executing a function cooperating with a disabled application in a mobile terminal in accordance with one embodiment; and

FIGS. 16 to 18 are conceptual views showing a method for displaying an icon corresponding to a disabled application in a mobile terminal in accordance with one embodiment.

### DETAILED DESCRIPTION OF THE INVENTION

Description will now be given in detail of an antenna device and an electronic device having the same according to the embodiments, with reference to the accompanying drawings. For the sake of brief description with reference to the drawings, the same or equivalent components will be given the same reference numbers, and description thereof will not be repeated. A suffix “module” or “unit” used for constituent elements disclosed in the following description is merely intended for easy description of the specification, and the suffix itself does not give any special meaning or function. In describing the present invention, if a detailed explanation for a related known function or construction is considered to unnecessarily divert the gist of the present disclosure, such explanation has been omitted but would be understood by those skilled in the art. The accompanying drawings are used to help easily understood the technical idea of the present invention and it should be understood that the idea of the present disclosure is not limited by the accompanying drawings.

Electronic devices described herein may include cellular phones, smart phones, laptop computers, digital broadcasting terminals, personal digital assistants (PDAs), portable multimedia players (PMPs), navigators, slate PCs, tablet PC, ultra books and the like. However, it may be easily understood by those skilled in the art that the configuration according to the embodiments of this specification can be applied to stationary terminals such as digital TV, desktop computers and the like excluding a situation of being applicable only to the electronic devices.

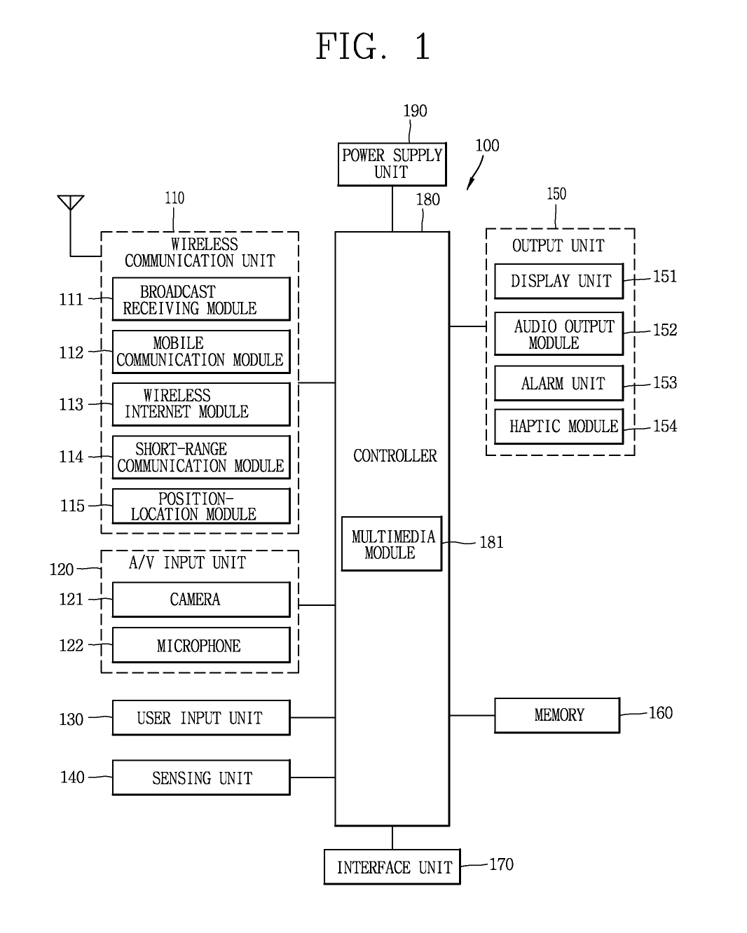

FIG. 1 is a block diagram of an electronic device in accordance with one embodiment.

Mobile terminals described in this specification may include cellular phones, smart phones, laptop computers, digital broadcasting terminals, personal digital assistants (PDAs), portable multimedia players (PMPs), navigators, and the like. However, it may be easily understood by those skilled in the art that the configuration according to the embodiments of this specification can be applied to stationary terminals such as digital TV, desktop computers and the like excluding a situation of being applicable only to the mobile terminals.

FIG. 1 is a block diagram of a mobile terminal 100 in accordance with one embodiment.

The mobile terminal 100 may comprise components, such as a wireless communication unit 110, an Audio/Video (A/V) input unit 120, a user input unit 130, a sensing unit 140, an output unit 150, a memory 160, an interface unit 170, a controller 180, a power supply 190 and the like. FIG. 1 shows the mobile terminal 100 having various components, but it is understood that implementing all of the illustrated components is not a requirement. Greater or fewer components may alternatively be implemented.

Hereinafter, each component is described in sequence.

The wireless communication unit 110 may typically include one or more modules which permit wireless communications between the mobile terminal 100 and a wireless communication system or between the mobile terminal 100 and a network within which the mobile terminal 100 is located. For example, the wireless communication unit 110 may include a broadcast receiving module 111, a mobile communication module 112, a wireless Internet module 113, a short-range communication module 114, a location information module 115 and the like.

The broadcast receiving module 111 receives a broadcast signal and/or broadcast associated information from an external broadcast managing entity via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 111 may be configured to be suitable for every broadcast system transmitting broadcast signals as well as the digital broadcasting systems.

Broadcast signals and/or broadcast associated information received via the broadcast receiving module 111 may be stored in a suitable device, such as a memory 160.

The mobile communication module 112 transmits/receives wireless signals to/from at least one of network entities (e.g., base station, an external mobile terminal, a server, etc.) on a mobile communication network. Here, the wireless signals may include audio call signal, video (telephony) call signal, or various formats of data according to transmission/reception of text/multimedia messages.

The mobile communication module 112 may implement a video call mode and a voice call mode. The video call mode indicates a state of calling with watching a callee's image. The voice call mode indicates a state of calling without watching the callee's image. The wireless communication module 112 may transmit and receive at least one of voice and image in order to implement the video call mode and the voice call mode.

The wireless Internet module 113 supports wireless Internet access for the mobile terminal. This module may be internally or externally coupled to the mobile terminal 100. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module 114 denotes a module for short-range communications. Suitable technologies for implementing this module may include BLUETOOTH™, Radio Frequency IDentification (RFID), Infrared Data Association (IrDA), Ultra-WideBand (UWB), ZIGBEE™, and the like.

The location information module 115 denotes a module for detecting or calculating a position of a mobile terminal. An example of the location information module 115 may include a Global Position System (GPS) module.

Referring to FIG. 1, the A/V input unit 120 is configured to provide audio or video signal input to the mobile terminal. The A/V input unit 120 may include a camera 121 and a microphone 122. The camera 121 receives and processes image frames of still pictures or video obtained by image sensors in a video call mode or a capturing mode. The processed image frames may be displayed on a display unit 151.

The image frames processed by the camera 121 may be stored in the memory 160 or transmitted to the exterior via the wireless communication unit 110. Two or more cameras 121 may be provided according to the configuration of the mobile terminal.

The microphone 122 may receive an external audio signal while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 in the phone call mode. The microphone 122 may include assorted noise removing algorithms to remove noise generated in the course of receiving the external audio signal.

The user input unit 130 may generate input data input by a user to control the operation of the mobile terminal. The user input unit 130 may include a keypad, a dome switch, a touchpad (e.g., static pressure/capacitance), a jog wheel, a jog switch and the like.

The sensing unit 140 provides status measurements of various aspects of the mobile terminal. For instance, the sensing unit 140 may detect an open/close status of the mobile terminal, a change in a location of the mobile terminal 100, a presence or absence of user contact with the mobile terminal 100, the location of the mobile terminal 100, acceleration/deceleration of the mobile terminal 100, and the like, so as to generate a sensing signal for controlling the operation of the mobile terminal 100. For example, regarding a slide-type mobile terminal, the sensing unit 140 may sense whether a sliding portion of the mobile terminal is open or closed. Other examples include sensing functions, such as the sensing unit 140 sensing the presence or absence of power provided by the power supply 190, the presence or absence of a coupling or other connection between the interface unit 170 and an external device.

The output unit 150 is configured to output an audio signal, a video signal or a tactile signal. The output unit 150 may include a display unit 151, an audio output module 152, an alarm unit 153 and a haptic module 154.

The display unit 151 may output information processed in the mobile terminal 100. For example, when the mobile terminal is operating in a phone call mode, the display unit 151 will provide a User Interface (UI) or a Graphic User Interface (GUI), which includes information associated with the call. As another example, if the mobile terminal is in a video call mode or a capturing mode, the display unit 151 may additionally or alternatively display images captured and/or received, UI, or GUI.

The display unit 151 may be implemented using, for example, at least one of a Liquid Crystal Display (LCD), a Thin Film Transistor-Liquid Crystal Display (TFT-LCD), an Organic Light-Emitting Diode (OLED), a flexible display, a three-dimensional (3D) display, an e-ink display or the like.

Some of such displays 151 may be implemented as a transparent type or an optical transparent type through which the exterior is visible, which is referred to as ‘transparent display’. A representative example of the transparent display may include a Transparent OLED (TOLED), and the like. The rear surface of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the mobile terminal 100. For instance, a plurality of the displays 151 may be arranged on one surface to be spaced apart from or integrated with each other, or may be arranged on different surfaces.

Here, if the display unit 151 and a touch sensitive sensor (referred to as a touch sensor) have a layered structure therebetween, the structure may be referred to as a touch screen. The display unit 151 may be used as an input device rather than an output device. The touch sensor may be implemented as a touch film, a touch sheet, a touchpad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also touch pressure.

When touch inputs are sensed by the touch sensors, corresponding signals are transmitted to a touch controller. The touch controller processes the received signals, and then transmits corresponding data to the controller 180. Accordingly, the controller 180 may sense which region of the display unit 151 has been touched.

Still referring to FIG. 1, a proximity sensor 141 may be arranged at an inner region of the mobile terminal 100 covered by the touch screen, or near the touch screen. The proximity sensor 141 indicates a sensor to sense presence or absence of an object approaching to a surface to be sensed, or an object disposed near a surface to be sensed, by using an electromagnetic field or infrared rays without a mechanical contact. The proximity sensor 141 has a longer lifespan and a more enhanced utility than a contact sensor.

The proximity sensor 141 may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this instance, the touch screen (touch sensor) may be categorized into a proximity sensor.

Hereinafter, for the sake of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor 141 senses proximity touch, and proximity touch patterns (e.g., distance, direction, speed, time, position, moving status, etc.). Information relating to the sensed proximity touch and the sensed proximity touch patterns may be output onto the touch screen.

The audio output module 152 may output audio data received from the wireless communication unit 110 or stored in the memory 160, in a call-receiving mode, a call-placing mode, a recording mode, a voice recognition mode, a broadcast reception mode, and so on. The audio output module 152 may output audio signals relating to functions performed in the mobile terminal 100, e.g., sound alarming a call received or a message received, and so on. The audio output module 152 may include a receiver, a speaker, a buzzer, and so on.

The alarm unit 153 outputs signals notifying occurrence of events from the mobile terminal 100. The events occurring from the mobile terminal 100 may include call received, message received, key signal input, touch input, and so on. The alarm unit 153 may output not only video or audio signals, but also other types of signals such as signals notifying occurrence of events in a vibration manner. Since the video or audio signals can be output through the display unit 151 or the audio output module 152, the display unit 151 and the audio output module 152 may be categorized into a part of the alarm unit 153.

The haptic module 154 generates various tactile effects which a user can feel. A representative example of the tactile effects generated by the haptic module 154 includes vibration. Vibration generated by the haptic module 154 may have a controllable intensity, a controllable pattern, and so on. For instance, different vibration may be output in a synthesized manner or in a sequential manner.

The haptic module 154 may generate various tactile effects, including not only vibration, but also arrangement of pins vertically moving with respect to a skin being touched (contacted), air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 154 may be configured to transmit tactile effects (signals) through a user's direct contact, or a user's muscular sense using a finger or a hand. The haptic module 154 may be implemented in two or more in number according to the configuration of the mobile terminal 100.

The memory 160 may store a program for the processing and control of the controller 180. Alternatively, the memory 160 may temporarily store input/output data (e.g., phonebook data, messages, still images, video and the like). Also, the memory 160 may store data related to various patterns of vibrations and audio output upon the touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, optical disk, and the like. Also, the mobile terminal 100 may operate a web storage which performs the storage function of the memory 160 on the Internet.

The interface unit 170 may generally be implemented to interface the mobile terminal with external devices. The interface unit 170 may allow a data reception from an external device, a power delivery to each component in the mobile terminal 100, or a data transmission from the mobile terminal 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

The identification module may be configured as a chip for storing various information required to authenticate an authority to use the mobile terminal 100, which may include a User Identity Module (UIM), a Subscriber Identity Module (SIM), and the like. Also, the device having the identification module (hereinafter, referred to as ‘identification device’) may be implemented in a type of smart card. Hence, the identification device can be coupled to the mobile terminal 100 via a port.

Also, the interface unit 170 may serve as a path for power to be supplied from an external cradle to the mobile terminal 100 when the mobile terminal 100 is connected to the external cradle or as a path for transferring various command signals input from the cradle by a user to the mobile terminal 100. Such various command signals or power input from the cradle may operate as signals for recognizing that the mobile terminal 100 has accurately been mounted to the cradle.

The controller 180 typically controls the overall operations of the mobile terminal 100. For example, the controller 180 performs the control and processing associated with telephony calls, data communications, video calls, and the like. The controller 180 may include a multimedia module 181 which provides multimedia playback. The multimedia module 181 may be configured as part of the controller 180 or as a separate component.

The controller 180 can perform a pattern recognition processing so as to recognize writing or drawing input on the touch screen as text or image.

Also, the controller 180 may execute a lock state, in which a user is restricted from inputting a control command for applications, when a state of the mobile terminal satisfies a preset condition. The controller 180 may control a lock screen, which is displayed in the lock state, based upon a touch input detected on the display unit 151 (hereinafter, referred to ‘touch screen’) in the lock state.

The power supply 190 provides power required by various components under the control of the controller 180. The provided power may be internal power, external power, or combination thereof.

Various embodiments described herein may be implemented in a computer-readable medium using, for example, software, hardware, or some combination thereof.

For a hardware implementation, the embodiments described herein may be implemented within one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, microprocessors, other electronic units designed to perform the functions described herein, or a selective combination thereof. In some instances, such embodiments are implemented by the controller 180.

For software implementation, the embodiments such as procedures and functions may be implemented together with separate software modules each of which performs at least one of functions and operations.

The software codes can be implemented with a software application written in any suitable programming language. Also, the software codes may be stored in the memory 160 and executed by the controller 180.

Hereinafter, description will be given of the structure of the mobile terminal or an electronic device having those components of the mobile terminal in accordance with the embodiment shown in FIG. 1.

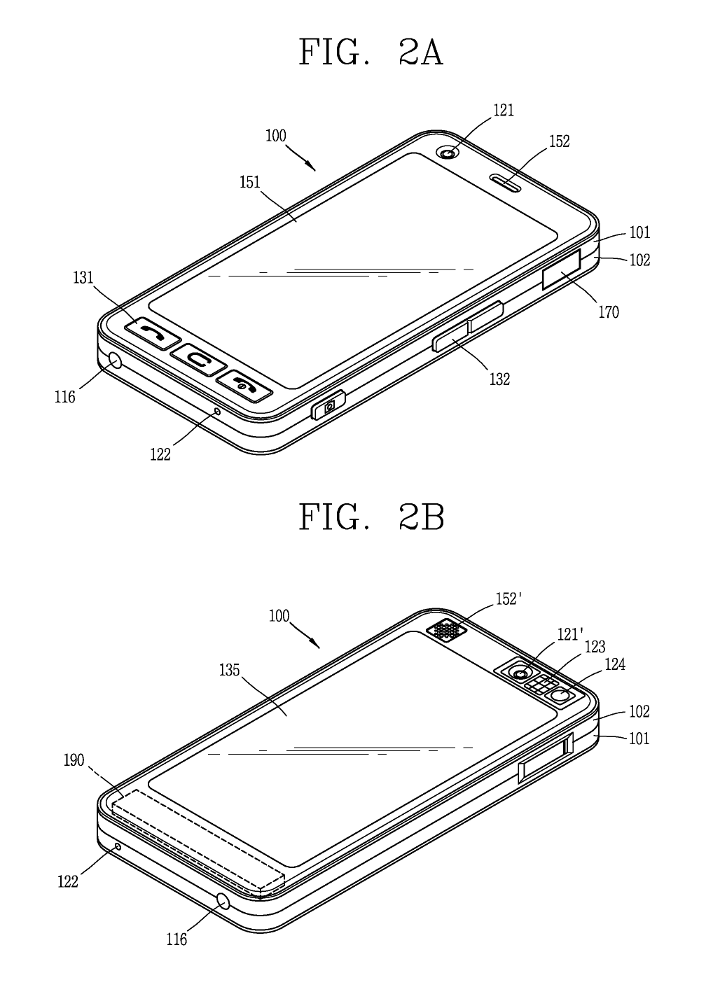

FIG. 2A is a front perspective view of one example of the mobile terminal or an electronic device, and FIG. 2B is a rear perspective view of the mobile terminal shown in FIG. 2A.

The mobile terminal 100 disclosed herein includes a bar-type terminal body. However, the present application is not limited to this type of terminal, but is also applicable to various structures of terminals such as slide type, folder type, swivel type, swing type, and the like, in which two or more bodies are combined with each other in a relatively movable manner.

As shown in FIGS. 2A and 2B, a terminal main body (hereinafter, referred to as ‘body’) 100 may include a front surface, side surfaces and a rear surface. Also, the body may have both ends formed in a lengthwise direction.

The body may include a case (or referred to as casing, housing, cover, etc.) defining an appearance of the mobile terminal 100. In this embodiment, the case may be divided into a front surface 101 (referred to as a front case) and a rear surface 102 (referred to as a rear case). A space formed between the front and rear cases 101 and 102 may accommodate various electronic components. At least one intermediate case may further be disposed between the front and the rear cases 101 and 102.

The terminal body is shown having a display unit 151, an audio output module 152, a camera 121, a user input unit 130/131, 132, a microphone 122, an interface unit 170, and the like.

The display unit 151 may occupy most of a principal surface of the front case 101. The audio output module 152 and the camera 121 may be disposed near one of both end portions of the display unit 151, and the user input unit 131 and the microphone 122 on the other end portion of the display unit 151. The user input unit 131, the interface unit 170 and the like may be disposed on side surfaces of the front and rear cases 101 and 102. The microphone 122 may be disposed on the other end of the body 100.

The user input unit 130 may be manipulated to allow inputting of commands for controlling operations of the mobile terminal 100, and include a plurality of first manipulation units 131, 132. The plurality of manipulation units 131, 132 may be referred to as a manipulating portion. Such manipulating portion can employ any tactile manner that a user can touch or tap for manipulation.

The first and second manipulation units 131, 132 may be set to allow inputting of various contents. For example, the first manipulation unit 131 may be configured to input commands such as START, END, SCROLL or the like, and the second manipulation unit 132 may be configured to input commands, such as a volume adjustment of sounds output from the audio output module 152, conversion of the display module 210 into a touch recognition mode, or the like.

The rear case 102 of the terminal body may further include a camera 121′. The camera 121′ faces a direction which is opposite to a direction faced by the camera 121 (see FIG. 2A), and may have different pixels from those of the camera 121.

For example, the camera 121 may operate with relatively lower pixels (lower resolution). Thus, the camera 121 may be useful when a user can capture his face and send it to another party during a video call or the like. On the other hand, the camera 121′ may operate with a relatively higher pixels (higher resolution) such that it can be useful for a user to obtain higher quality pictures for later use. The cameras 121 and 121′ may be installed in the terminal body to be rotatable or popped up.

A flash 123 and a mirror 124 may additionally be disposed adjacent to the camera 121′. The flash 123 operates in conjunction with the camera 121′ when taking a picture using the camera 121′. The mirror 124 can cooperate with the camera 121′ to allow a user to photograph himself in a self-portrait mode.

Referring to FIG. 2B, an audio output module 152′ may further be disposed at a rear face of the terminal body, namely, the rear case 102. The audio output module 152′ can cooperate with the audio output module 152 (see FIG. 2A) to provide stereo output. Also, the audio output module 152′ may be configured to operate as a speakerphone.

A power supply unit 190 for supplying power to the mobile terminal 100 may be mounted in the terminal body. The power supply unit 190 may be mounted in the terminal body or detachably coupled directly onto the outside of the terminal body.

The rear case 102 may include a touchpad 135 for detecting a touch input. Similar to the display module 210, the touchpad 135 may be implemented as a light-transmissive type. Here, if the display unit 151 is configured to output visual information from both surfaces, the visual information can be recognized through the touchpad 135. The information output from the both surfaces may all be controlled by the touchpad 135. Unlike to this, a display may further be mounted on the touchpad 135 so as to configure a touch screen even on the rear case 102.

The touchpad 135 may operate mutually in association with the display unit 151 of the front case 101. The touchpad 135 may be provided on the rear of the display unit 151 in parallel to each other. The touchpad 135 may have a size the same as or smaller than the size of the display unit 151.

The controller 180 of the mobile terminal according to the one embodiment which may include at least one of those aforementioned components may provide a function of disabling (deactivating, stopping use of) an application installed in the terminal.

Here, the disabling function refers to reducing an actual size of a memory allocated to an application for enabling (activating, operating, running) the application. When an application is disabled, the mobile terminal according to the present disclosure may save a size of a memory allocated to the disabled application. Hence, although the application is not actually deleted, the mobile terminal may have the same effect as reducing an allocated size of the memory for operating (executing) an application due to deletion of the application.

Here, memories associated with applications may be classified into a memory for storing data corresponding to applications, and a memory for activating (or executing) applications. Especially, the present disclosure may effectively save the memory used for activating (or executing) an application.

Therefore, even if data stored in the memory in association with an application is not deleted, the memory used for activating (executing) the application may be saved. This may result in improvement of speed for activating other applications.

In the meantime, the memory for activating (executing) the application may be a random access memory (RAM), and used for loading an application or temporarily storing data associated with the application.

Hence, in response to a request from a terminal operator or a communication operator, a user may execute a disabling function with respect to a pre-installed application or an uninstallation-restricted (uninstallation-prohibited) application, to secure (save) a memory allocated for executing an application which is not frequently used or is unnecessary.

The mobile terminal according to the present disclosure may also provide the disabling function even for an application downloaded by a user as well as the application which is pre-installed or prohibited from being uninstalled, securing room within the memory and selectively activating an application depending on a user's requirement.

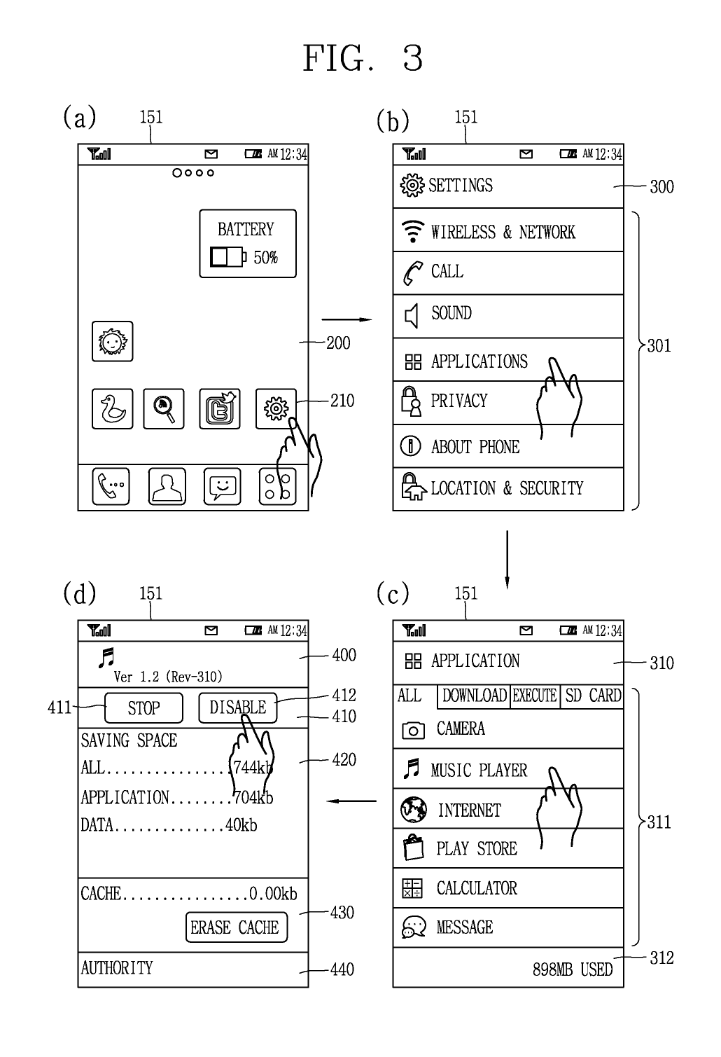

Hereinafter, description will be given in more detail of a method of converting a state of an enabled (activated, active) application into a disabled (deactivated) state with reference to the accompanying drawings. FIGS. 3A to 6 are conceptual views showing a method of changing an enabled (activated) state of an application in a mobile terminal in accordance with one embodiment.

In a mobile terminal according to the present disclosure, as shown in FIG. 3A, a user may select a settings icon 210, which is located on at least one of a home screen page and a menu page and associated with terminal settings. The user may thus enter a terminal setting page 300, as shown in FIG. 3B. FIG. 3B illustrates an example of the terminal setting page 300, which may include various user interface environments.

Referring to FIG. 3B, the terminal setting page 300 may display items 301 corresponding to one or more functions, respectively. The user may enter one of the items to change or control settings associated with the terminal. The mobile terminal according to the present disclosure may separately include an “application” item for controlling whether or not to enable an application of those items 301. When the application item is selected, the controller 180, as shown in FIG. 3C, may control the display unit 151 to output application items 311 installed in the terminal.

Here, an application installed in the terminal may be an application which a user has downloaded from an external network as the user has intended, or an application which is pre-installed in the terminal in response to a request by a terminal operator or a communication operator.

Every installed application may be displayed on the application items 311 shown in FIG. 3C, regardless of whether the application was installed by the user intention or a pre-installed application. Also, the controller 180 may control the display unit 151 to discriminatively display the application installed by the user intention or the pre-installed application on the application items 311 shown in FIG. 3C.

Also, the setting screen shown in FIG. 3C may include a memory item 312 for displaying a size of a memory used for executing an application installed in the terminal.

Referring to FIG. 3C, when one of the application items 311 is selected, the controller 180, as shown in FIG. 3D, may control the display unit 151 to output a setting page 400 on which an application corresponding to the selected item is controllable.

For example, when “music player” as one application item 311 is selected on FIG. 3C, the display unit 151, as shown in FIG. 3D, may output the setting page 400 for controlling the “music player” application.

The setting page 400 may allow for forcibly shutting down an application, checking or controlling a memory status associated with an application, controlling a right, or controlling a cache. A user may also execute a function of disabling the use of an application on the setting page 400.

Whether or not to disable the application may be selected, as shown in FIG. 3D, using a function icon 412 arranged on the setting page 400.

Here, the term “disabling the use of the application,” as aforementioned, refers to reducing an actual size of the memory allocated to the application for executing the application. Meanwhile, when the use of the application is disabled, the controller 180 may not uninstall the disabled application from the terminal. However, the size of the memory allocated to the disabled application may be reduced to be the same as the disabled application being uninstalled.

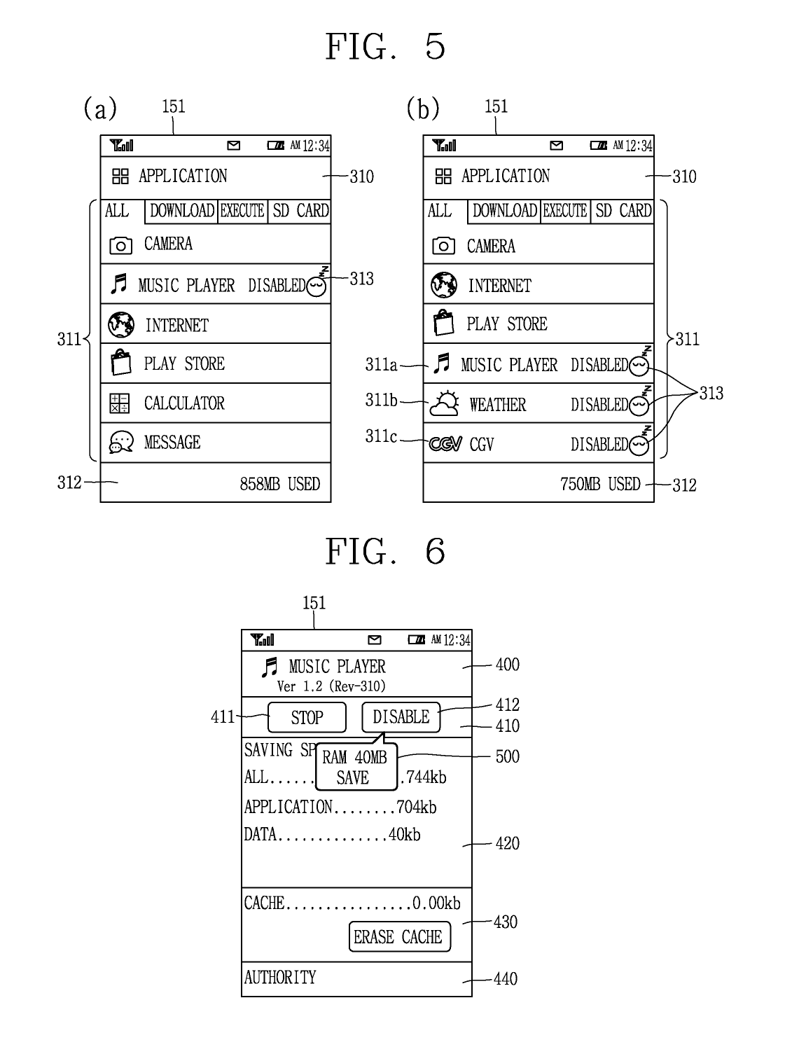

For example, illustrating an example that the size of the memory allocated to execute a “music player” application changes when the application is disabled, it may be noticed that the size of the memory displayed on the memory item 312 of FIG. 3C is different from the size of the memory displayed on the memory item 312 shown in FIG. 5A.

Therefore, when the application “music player” is converted into the disabled state, the mobile terminal according to the present disclosure may save the capacity of the memory, which is used for executing the corresponding application, by approximately 40 MB. Here, the saved capacity of the memory as such application is converted into the disabled state may depend on a type of application. Also, referring to FIG. 5B, when a plurality of applications are converted into the disabled state, the capacity of the memory used for running (executing) those applications may further be reduced.

In the meantime, the aforementioned application disabling function may be applied to every application installed in the terminal, and may also be applied only to an application meeting a preset condition.

Here, the application meeting the preset condition may be variously set by the controller 180 or the user. For example, such application may be an application which is provided by a terminal operator or a mobile communication operator and prohibited from being uninstalled by the user. Also, the controller 180 may not provide the disabling function for an application which is necessary to operate the terminal even if the application is an uninstallation-prohibited application. For example, the controller 180 may not provide the disabling function for ‘setting application’ for controlling overall settings of the terminal, a ‘call’ application for executing basic functions of the terminal, and the like. Hence, the controller 180 may deactivate the function icon 412 ‘disable’ shown in FIG. 3D with respect to essential applications.

In addition to those aforementioned examples, the types of applications to which the disabling function is provided may change in various ways according to settings in the terminal or a request by the terminal operator or the communication operator. The method of entering the setting page 400 may also variously change according to the settings of the controller 180 or the user, in addition to the method illustrated in FIGS. 3A-3D.

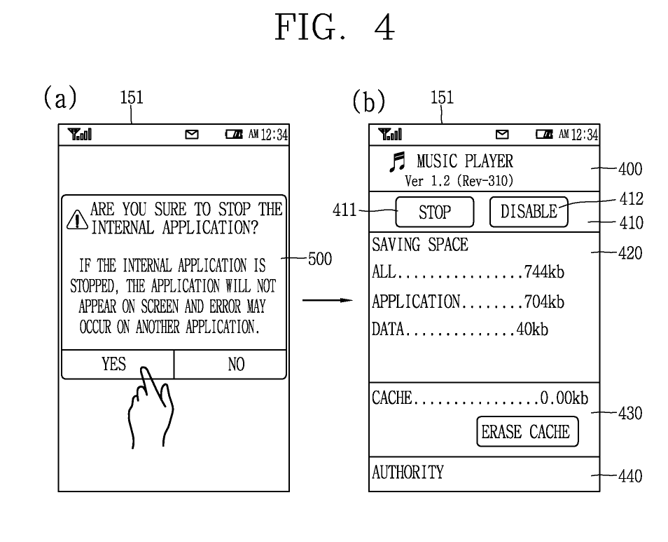

Still referring to FIG. 3D, when the function icon 412 ‘disable’ for disabling the application ‘music player’ is selected by the user, the controller 180, as shown in FIG. 4A, may output a pop-up window 500 for allowing a user to check the conversion of the application into the disabled state.

When the application is converted into the disabled state, the controller 180 may also output notification information, which notifies an event which may happen in the terminal, on the pop-up window 500.

When a control command for disabling the application is applied via the pop-up window 500, the controller 180 may convert the application into the disabled state. Referring to FIG. 4B, the function icon 412 for selecting the disabled state on the setting page 400 of the application ‘music player’ may be displayed by being converted into the function icon 412 for converting the application ‘music player’ into an enabled (activated, active) state. Therefore, the user may convert the disabled application back into the enabled state by selecting the function icon 412.

When the application is converted into the disabled state, the controller 180, as shown in FIG. 5A, application state information 313 may be output on one area of the disabled application item such that the user can recognize the disabled application on the page 310 displaying the application items 311 installed in the terminal. As shown, the state information 313 may be displayed using at least one of text and an image. The controller 180 may also control the state information 313 to be displayed in the form of an icon. Consequently, when the state information 313 is displayed as an icon, the disabled state of the application may be simply converted into the enabled state in response to reception of a control command using the state information icon 313.

As one example, referring to FIG. 3C and FIG. 5A, even if a predetermined application, for example, ‘music player’ is converted into a disabled state, a position where the application ‘music player’ is arranged among the application items 311 may not change. This may allow the disabled application to be quickly found when the user enables the disabled application next time. As such, the controller 180 may maintain the arrangement sequence of the plurality of applications, irrespective of at least one of the plurality of application being converted into the disabled state.

As another example, referring to FIG. 5B, the controller 180 may display the application items 311 installed in the terminal on the page 310 such that application items 311a, 311b and 311c in a disabled state can be discriminative from the other application items in an enabled state. Here, the user may convert the disabled applications into the enabled state at once. In addition to those examples, the method of displaying the disabled application items may change in various ways.

As described above, the mobile terminal according to the present disclosure may be allowed to convert a state of an application into a disabled state so as to prevent an activation of an application which is not frequently used. This may result in reduction of the usage of the memory allocated to the application.

Also, when the application is converted into the disabled state using the pop-up window 500 on the setting page 400 shown in FIG. 6, the controller 180 may provide the user with information relating to a saved size of the memory, especially, information relating to a RAM used for executing the application.

The controller 180 may control the display unit 151 to display information, which relates to an improved speed by virtue of the saving of the memory, on the pop-up window 500 when an application is disabled.

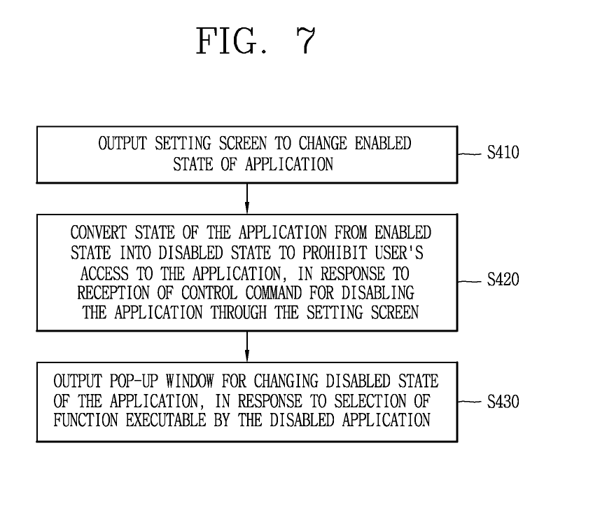

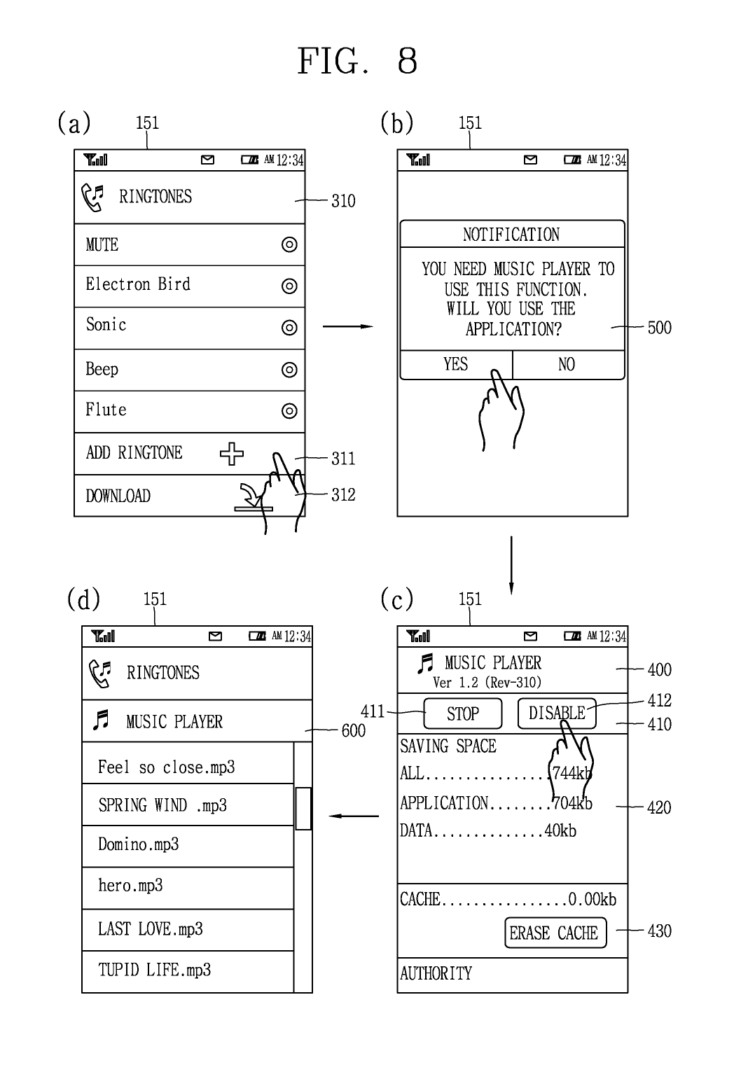

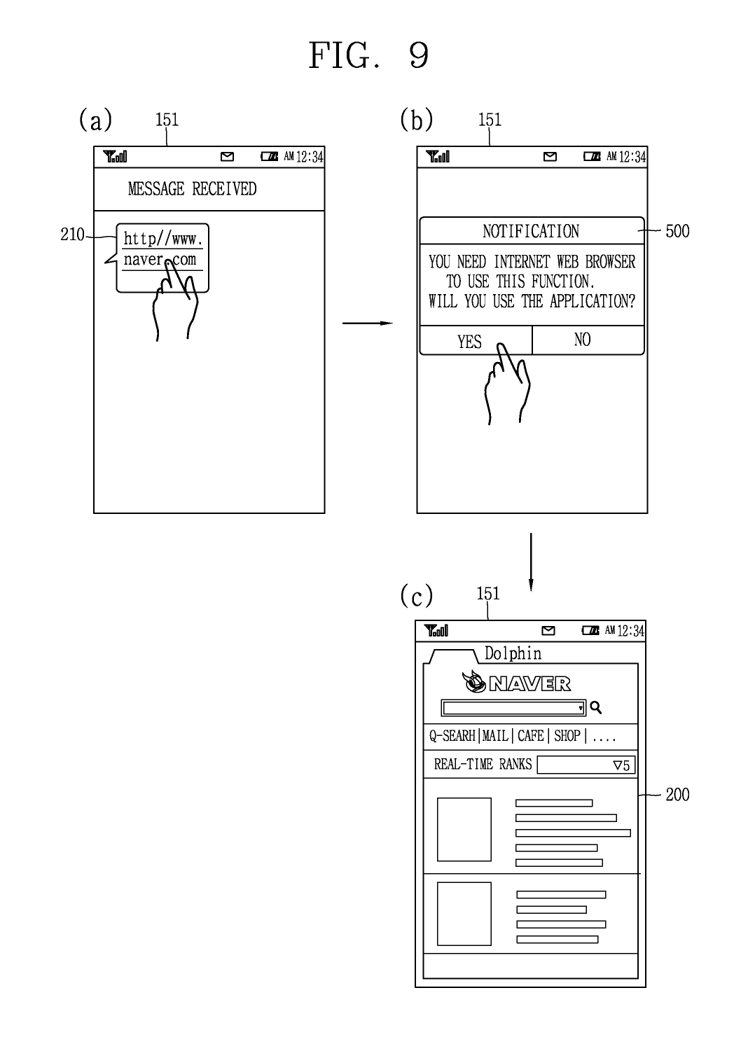

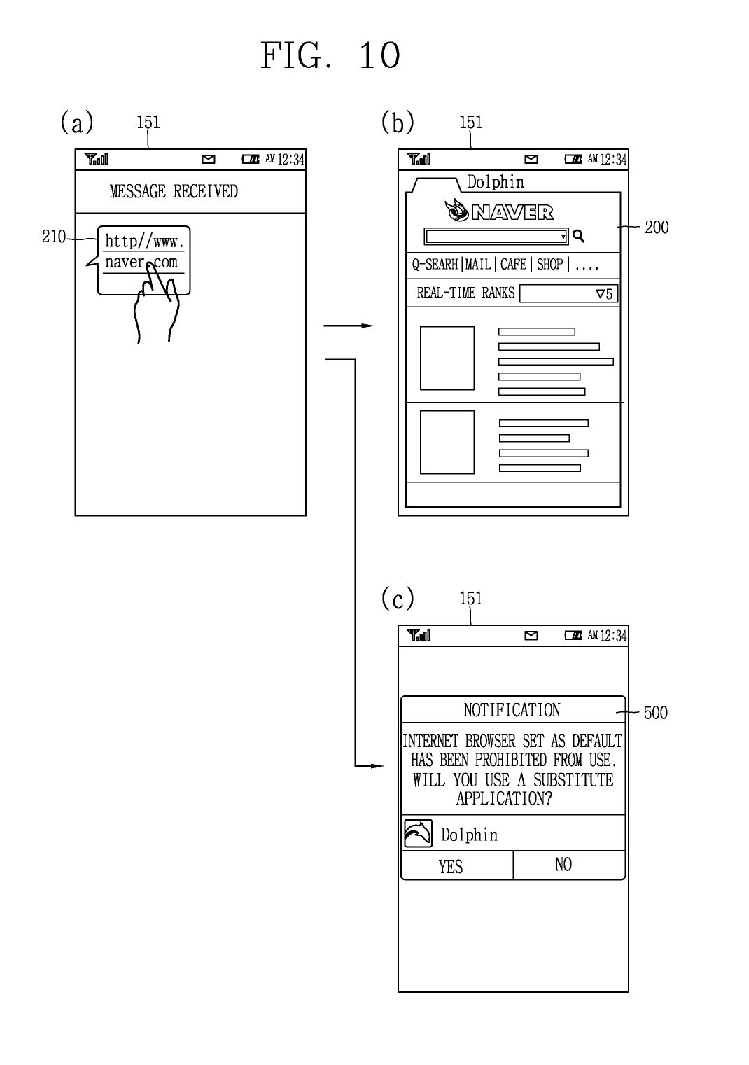

Hereinafter, description will be given in more detail of a method of controlling a terminal when an application, which has been disabled during use of the terminal, is necessary to be enabled, with reference to the accompanying drawings. FIG. 7 is a flowchart showing a control method for enabling (activating) a disabled (deactivated) application in a mobile terminal in accordance with one embodiment. FIGS. 8A-9C are conceptual views showing the control method shown in FIG. 7.

First, in a mobile terminal according to the present disclosure, a setting screen may be output to change an enabled state of an application into a disabled state in response to a user selection (S410).

Next, upon reception of a control command for disabling the application from a user through the setting screen, the controller 180 may convert the application from an enabled state into the disabled state to prohibit the user's access to the application (S420). The method of converting the state of the application into the disabled state through the setting screen in the steps S410 and S420 has been illustrated with reference to FIGS. 3A to 5B, so detailed description thereof will not be repeated.

As such, in a disabled state of a predetermined application, when a function which is executable by the disabled application is selected by the user, the controller 180 may output a pop-up window for changing the disabled state of the application (S430).

In the meantime, the steps S410 and S420 may not be executed in series with the step S430. After the predetermined application is converted into the disabled state through the S410 and S420, only the step S430 may be repetitively carried out.

The function which is executable by the disabled application in the step S430 refers to having to use the disabled application to execute a specific function on another application. One example illustrates that a ‘music player’ application has to be used in a disabled state of the corresponding application. Referring to FIG. 8A, upon desiring to generate a ringtone using sound sources stored in the memory 160 on a ringtone setting screen 310 in addition to a preset ringtone, a user may select ‘add ringtone’ item 311. Here, it is assumed that the ‘music player’ application is essentially required for adding a ringtone through the ‘add ringtone’ item 311.

Hence, in a disabled state of the ‘music player’ application, when a function which requires the ‘music player’ application is selected, the controller 180, as shown in FIG. 8B, may output a pop-up window 500 for changing the disabled state of the ‘music player’ application into an enabled (activated) state.

The pop-up window 500 may output notification information which notifies that the ‘music player’ application has to change into the enabled state to use a function of adding a ringtone, and include select buttons to guide the change of the state of the ‘music player’ application into the enabled state.

That is, the pop-up window 500 may display notification information notifying that the corresponding application is in the disabled state, and guide information for receiving a control command to enable the disabled application.

Referring to FIGS. 8B and 8C, the controller 180 may output a setting screen 400 for enabling the disabled application on the display unit 151 based on a user selection.

That is, the controller 180 may convert a screen output on the display unit 151 into a setting screen for controlling the enabled state of the application. Upon reception of a control command for converting the disabled application into the enabled state through an enabling-related function icon 412 on the setting screen 400, the controller 180 may convert the disabled application into the enabled state.

When the disabled application is converted into the enabled state, the controller 180, as shown in FIG. 8D, may execute the function which is executable using the application which was disabled.

Therefore, the controller 180 may control a terminal operation to allow for execution of the function of adding the ringtone, using the ‘music player’ application converted into the enabled state.

In the meantime, in addition to the method, referring to FIG. 8C, of outputting the setting screen for converting the disabled application into the enabled state and enabling the application based on the control command received via the output setting screen, the mobile terminal according to the present disclosure may also be allowed, as shown in FIG. 6, to simply enable a disabled application using a pop-up window.

For example, referring to FIG. 9A, when a user selects an Internet address from a message 210 to which the corresponding Internet address is linked, the controller 180 may output a webpage corresponding to the Internet address on the display unit 151 using an ‘Internet web browser’ application. However, when the ‘internet web browser’ application installed in the terminal is in a disabled state, the controller 180, as shown in FIG. 9B, may output a pop-up window 500 to convert the ‘Internet web browser’ application from the disabled state into an enabled state. The pop-up window 500, as aforementioned in FIGS. 8A-8D, may display notification information notifying that the disabled application has been disabled and guide information for receiving a control command for enabling the disabled application.

When the control command for enabling the disabled application is received via the pop-up window 500, the controller 180 may not output the setting screen shown in FIG. 5 (especially, FIG. 8C), but automatically convert the disabled application into the enabled state. Afterwards, the controller 180 may execute a function using the application converted into the enabled state as shown in FIG. 9C.

Consequently, the controller 180, as shown in FIGS. 9B and 9C, may control the display unit 151 to output an Internet page corresponding to the Internet address linked to the message 210 (see FIG. 9A), in response to the generated control command based on the user selection via the pop-up window.

As described above, when the mobile terminal according to the present disclosure has to execute a function using a disabled application, it may receive state information relating to the disabled application and a control command for converting the disabled application into an enabled state from a user by use of a pop-up window.

The foregoing embodiment illustrates the situation where there is only one application in a disabled state as an application by which one function selected by a user is executable. That is, when there is also another application, in addition to the application in the disabled state, as the application for executing the one function, the controller 180 may control the terminal in a different manner from that shown in FIGS. 7 to 9C.

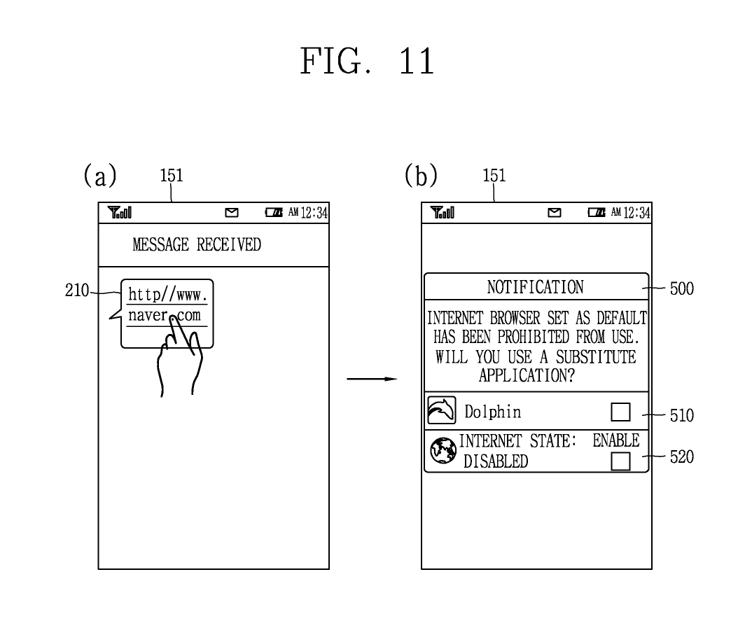

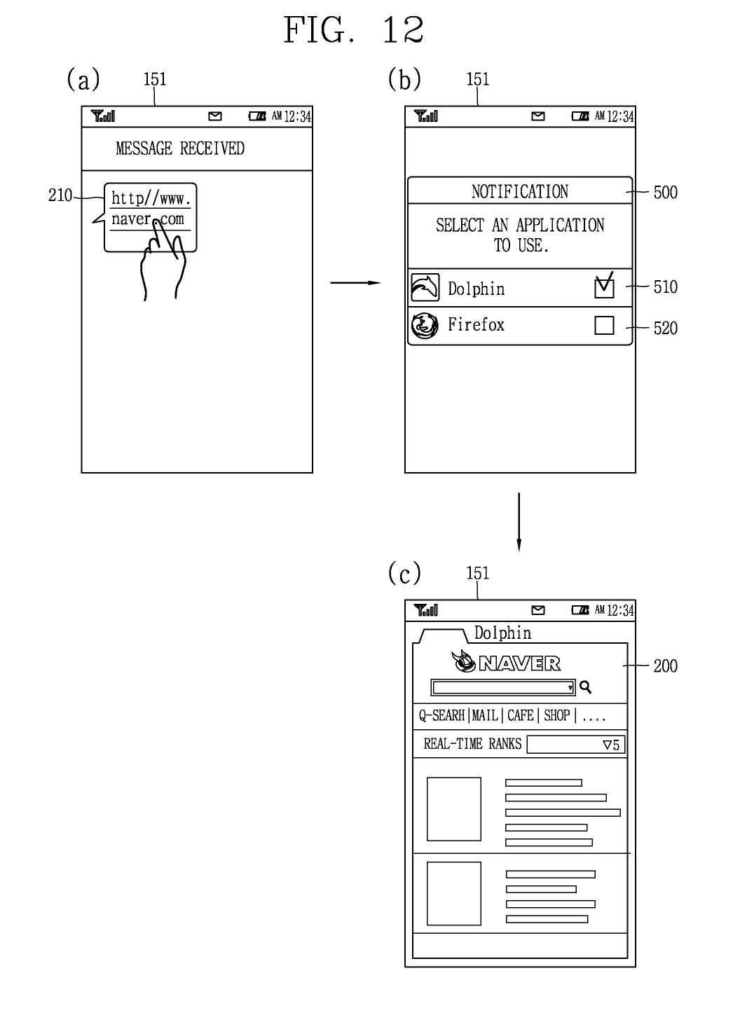

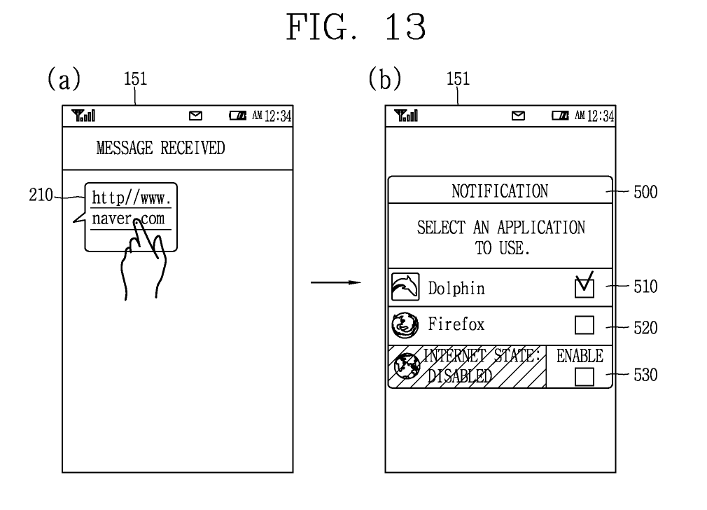

Hereinafter, description will be given in more detail of a control method of a terminal when there is another application which can substitute for a disabled application, with reference to the accompanying drawings. FIGS. 10A-11B are conceptual views showing an example that there is an application for substituting for a disabled application in a mobile terminal in accordance with one embodiment. FIGS. 12A to 13B are conceptual views showing an example that there is a plurality of applications for substituting for a disabled application in a mobile terminal in accordance with one embodiment.

In a disabled state of a predetermined application in a mobile terminal according to the present disclosure, when a user selects a function which is executable by the disabled application, the controller 180 may search whether or not there is another application, which is installed in the terminal and allows the function to be executable thereby, in addition to the disabled application. When there is another application which can substitute for the disabled application according to the search result, then the controller 180 may execute the function using the other application.

For example, referring to FIG. 10A, when a user selects an Internet address on a message 210 to which the corresponding Internet address is linked, the controller 180 may output a webpage corresponding to the Internet address on the display unit 151 using another application, which can substitute for a disabled ‘Internet web browser’ application. Here, when an application which has been set to execute a predetermined function selected by the user is not the disabled application, the controller 180 may not search for another application which can substitute for the disabled application, but execute the predetermined function using another application set to execute the predetermined function.

That is, in this situation, when an application which has been set as a default for executing a predetermined function is in a disabled state, if there is another application which can substitute for the disabled application set to execute the predetermined function, the controller 180 may execute the predetermined function using another application, without outputting a pop-up window which indicates the disabled state of the default application, as depicted in FIG. 10B.

Referring to FIG. 10C, the controller 180 may control the display unit 151 to output a select window 500 for selecting whether or not to enable (activate) a disabled application and whether or not to use another application for substituting for the disabled application. Here, when the user selects the use of another application through the select window 500, the controller 180 may execute the function using the other application.

FIG. 11A again depicts when a user selects an Internet address on a message 210. Referring to FIG. 11B, the controller 180 may output a plurality of items 510 and 520 on the select window 500 such that the user can select another application which can substitute for the application set as the default or enable the default application. The controller 180 may execute an operation corresponding to an item selected by the user through the select window 500.

Hereinafter, description will be given of an example where there is a plurality of applications which can substitute for a disabled application.

Referring to FIG. 12A, when a user selects an Internet address on a message 210 to which the corresponding Internet address is linked, the controller 180 may search for another application which can substitute for a disabled ‘Internet web browser’ application. Here, when an application, which has been set to execute a predetermined function (for example, outputting of an Internet webpage) selected by the user, is not the disabled application, then the controller 180 may not search for another application for substituting for the disabled application, but execute the predetermined function directly using another application set to execute the predetermined function.

When there is a plurality of applications for substituting for the disabled application according to the search result, the controller 180, as shown in FIG. 12B, may output a select window 500 such that the user can select one of the plurality of applications. When the user select one of the applications through the select window 500, the controller 180, as shown in FIG. 12C, may execute the predetermined function using the application selected by the user.

FIG. 13A again depicts when a user selects an Internet address on a message 210. Referring to FIG. 13B, the controller 180 may also display an item 530 corresponding to the disabled application on the select window 500, as well as items 510 and 520 corresponding to the plurality of searched applications. As aforementioned, the controller 180 may receive a control command for enabling the disabled application through the select window 500.

Referring to FIG. 13B, the controller 180 may display the item 530 corresponding to the disabled application to be distinguishable from the other items 510 and 520 such that disabled state information relating to the disabled application can be identified.

As described above, in the mobile terminal according to the present disclosure, when a function which is executable by using a disabled application is executed, a pop-up window for enabling the disabled application may be output. The pop-up window may allow for reception of a control command for converting the application into an enabled state. This may reduce a burden caused due to the user converting the disabled state of the application into the enabled state through a separate menu. In addition, the mobile terminal according to the present disclosure may allow for searching for another application which can substitute for a disabled application. Consequently, the user may execute a function desiring to execute in the terminal without inconvenience.

In the meantime, the selection of the function which is executable by the disabled application in the mobile terminal may be allowed by another application other than the disabled application. That is, when the function executable by the disabled application cooperates with another application, a method of outputting a function icon executable through the cooperated application on an execution screen of the other application may be differently controlled according to whether or not the cooperated application is in an enabled state.

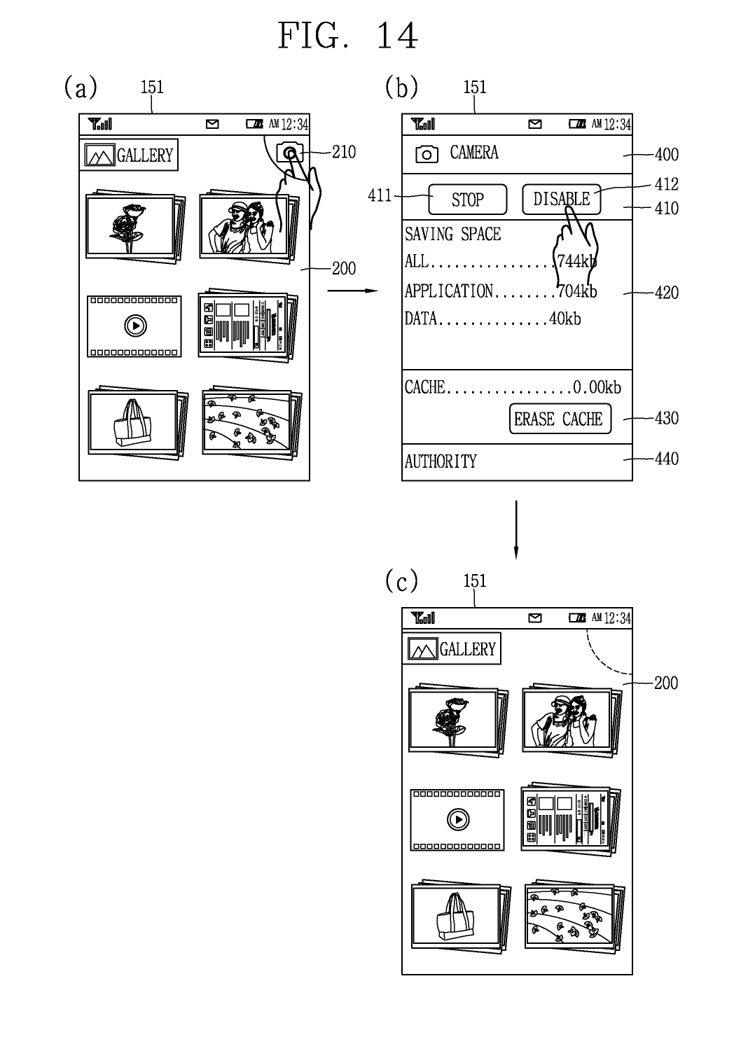

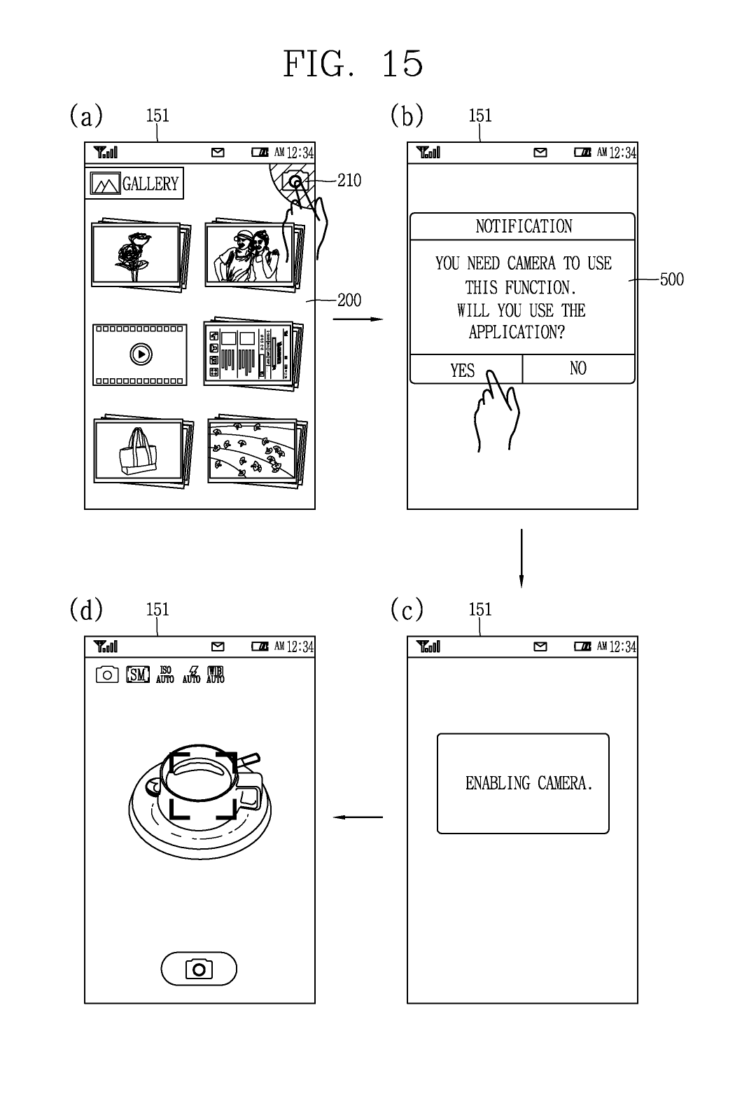

Hereinafter, a method of selecting a function executable by a disabled application will be described in more detail. FIGS. 14A-15D are conceptual views showing a method for executing a function cooperating with a disabled application in a mobile terminal in accordance with one embodiment.

For example, referring to FIG. 14A, a search for a photo stored in the memory 160 (see FIG. 1) may be allowed on a ‘gallery’ application, and additionally a direct entrance into a ‘camera’ application may be allowed by use of a function icon associated with ‘capture’ on the ‘gallery’ application. Here, it may be understood that the ‘camera’ application cooperates with the ‘gallery’ application.

Meanwhile, referring to FIG. 14B, when the ‘camera’ application has been converted into a disabled state, even if the function icon of the disabled ‘camera’ application is selected, the controller 180 may control the function not to be executed.

Therefore, referring to FIG. 14C, the controller 180 may not output a function icon 210 (see FIG. 14A) corresponding to the ‘camera’ application, which is cooperative with the ‘gallery’ application, on the display unit 151.

Referring to FIG. 15A, the controller 180 may control the display unit 151 to continuously display the function icon 210 corresponding to the function executable by the disabled application, irrespective of the state of the disabled application.

In addition, the controller 180 may control the display unit 151 such that the function icon 210 can be displayed in a different manner from the method of displaying the function icon 210 in the enabled state of the application, whereby the user can identify the disabled state of the application.

When the user selects the function icon 210, the controller 180, as shown in FIG. 15B, may display a pop-up window 500 which outputs guide information for converting the disabled state as well as information relating to the disabled state of the application corresponding to the function icon 210. The user is notified that the application is being enabled through a screen, as shown in FIG. 15C, before being able to use the application through the appropriate screen, such as seen in FIG. 15D.

Also, the controller 180 may execute the function of the disabled application when the disabled application is converted into the enabled state through the pop-up window 500 or a setting screen.

As described above, the mobile terminal according to the present disclosure may display an icon corresponding to a disabled application in a different manner of displaying the icon in an enabled state of the application on an execution screen of another application cooperative with the disabled application. This may provide the user with state information relating to the disabled application. In addition, the disabled application may be converted into the enabled state through a pop-up window, which may allow the user to convert the disabled application into the enabled state through a simple manipulation.

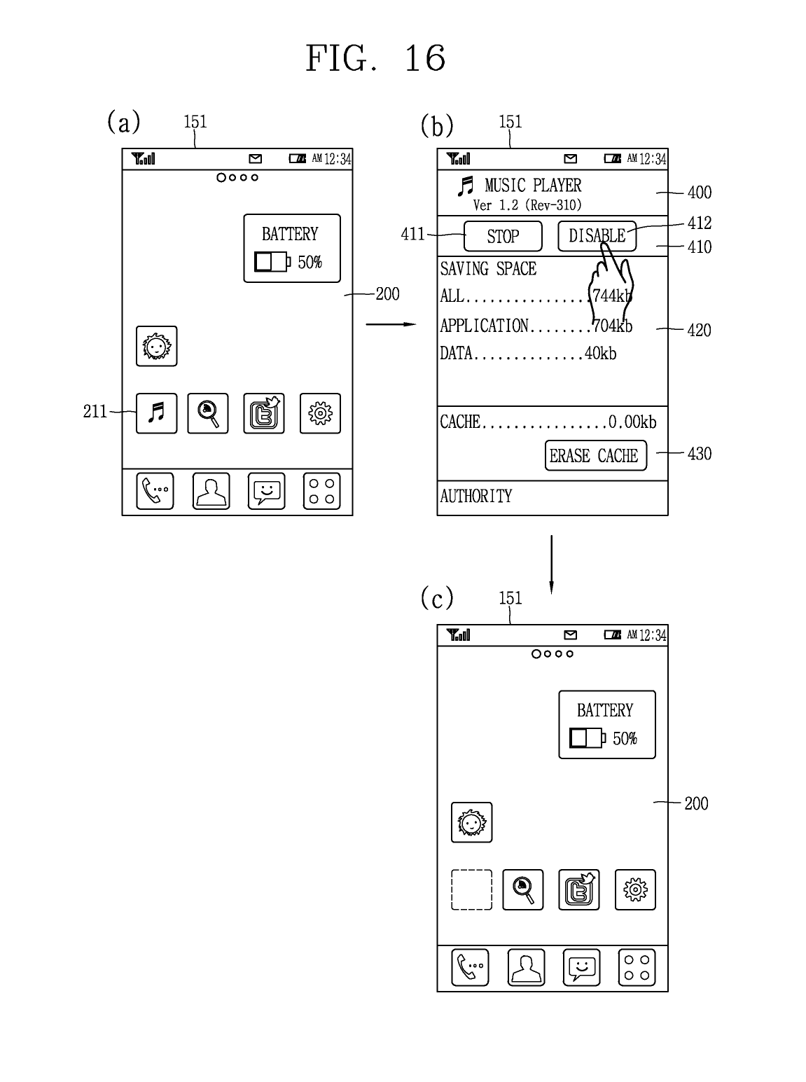

Hereinafter, description will be given in more detail of a method of displaying an icon of an application converted into a disabled state on a home screen or a menu screen when the application is converted into the disabled state. FIGS. 16A to 18C are conceptual views showing a method for displaying an icon corresponding to a disabled application in a mobile terminal in accordance with one embodiment.

In a mobile terminal according to the present disclosure, as shown in FIG. 16A, when an application corresponding to a home screen page (a menu page, a menu screen, etc.) is converted into a disabled state on a setting screen, such as through the screen depicted in FIG. 16B, the controller 180 may control the display unit 151 such that a first icon 211 corresponding to the disabled application cannot be displayed on the home screen (or the menu page), as shown in FIG. 16C. As an application which the user does not want to use is not displayed on the home screen page (or the menu page), the mobile terminal according to the present disclosure may save a space occupied by the icon corresponding to the disabled application on the display unit.

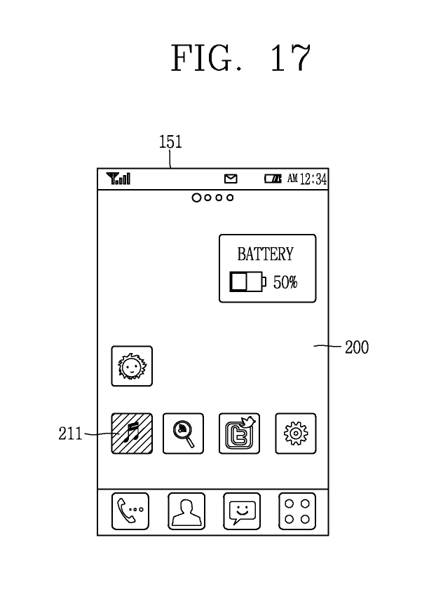

In addition, the mobile terminal according to the present disclosure, as shown in FIG. 17, may display the icon 211 corresponding to the disabled application to be distinguishable from the other icons. This may allow the user to recognize the state of the disabled application.

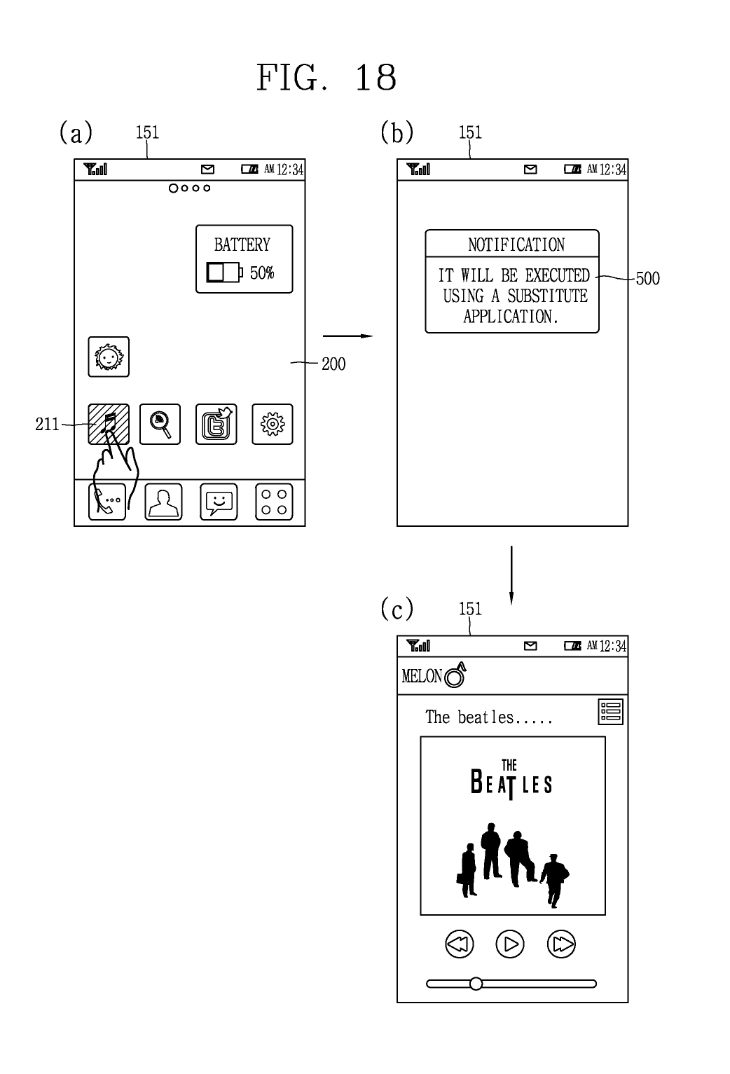

Referring to FIG. 18A, when the icon 211 corresponding to the disabled application is selected by the user, then the controller 180 may search for another application which can substitute for the disabled application. Referring to FIG. 18B, the controller 180 may output the pop-up window 500 to notify that a function of the disabled application is executed using the substitute application, and then execute the function, as shown in FIG. 18C.

The mobile terminal according to the present disclosure may receive a user's control command through the pop-up window 500, so as to execute the function of the disabled application using the substituent application in response to the user selection. The mobile terminal may also automatically execute the function of the disabled application using the substituent application without displaying the pop-up window.

As described above, in a mobile terminal and a control method thereof according to one embodiment of the present disclosure, a state of an application whose uninstallation is restricted (prohibited) may be converted into a disabled state so as to prevent activation of the application, thereby reducing the usage of a memory allocated to the uninstallation-restricted application.

Also, in a mobile terminal according to one embodiment, when the application converted into the disabled state is necessary to be used, a pop-up window for converting the disabled state of the application into an enabled state may be output, providing a user with information relating to the application converted into the disabled state. In addition, the user may simply enter a setting screen for converting the application from the disabled state into the enabled state, thereby reducing a burden caused due to changing the state of the application through a separate setting menu.

Further, in accordance with one embodiment of the present disclosure, the method can be implemented as computer-readable codes in a program-recorded medium. The computer-readable medium may include all types of recording devices each storing data readable by a computer system. Examples of such computer-readable media may include ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the mobile terminal.

The configurations and methods of the mobile terminal in the aforesaid embodiments may not be limitedly applied, but such embodiments may be configured by a selective combination of all or part of the embodiments so as to implement many variations.

The foregoing embodiments and advantages are merely examples and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the embodiments described herein may be combined in various ways to obtain additional and/or alternative embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a display unit configured to output a setting screen for setting an enabled state or a disabled state of an application; and
a controller configured to convert a state of the application from the enabled state into the disabled state to prohibit a user's access to the application based on a control command for disabling the application, the control command being received through the setting screen; and
the controller further configured to control the display unit to output a pop-up window for changing the state of the application, in response to selection of a function executable by the application in the disabled state.

2. The mobile terminal of claim 1, wherein the controller controls the display unit to output the setting screen thereon based on a user selection using the pop-up window, and converts the disabled state of the application into the enabled state in response to the control command for activating the application from the disabled state, the control command being received through the setting screen.

3. The mobile terminal of claim 2, wherein the controller executes the function using the application converted into the enabled state as the application in the disabled state is converted into the enabled state.

4. The mobile terminal of claim 2, wherein the pop-up window displays notification information notifying the user that the application in the disabled state has been enabled, and guide information for receiving a control command for enabling the application.

5. The mobile terminal of claim 1, wherein the controller executes the function using an other application without outputting the pop-up window when there is the other application, the other application being capable of substituting for the application in the disabled state allowing for execution of the function.

6. The mobile terminal of claim 5, wherein the controller controls the display unit to output a select window for selecting whether or not to enable the application in the disabled state and whether to use the other application, and
wherein the controller executes the function using the other application when use of the other application is selected through the select window.

7. The mobile terminal of claim 1, wherein the controller outputs a select window for allowing a user to select one of a plurality of applications, without outputting the pop-up window, when there is a plurality of applications for substituting for the application in the disabled state.

8. The mobile terminal of claim 7, wherein the select window comprises a plurality of items corresponding to the plurality of applications, respectively, and an item corresponding to the application in the disabled state.

9. The mobile terminal of claim 8, wherein the controller displays the item corresponding to the application in the disabled state to be distinguishable from the plurality of items respectively corresponding to the plurality of applications, for allowing identification of disabled state information relating to the application in the disabled state.

10. The mobile terminal of claim 1, wherein the controller minimizes a size of a memory allocated for running the application when the state of the application is converted from the enabled state to the disabled state.

11. The mobile terminal of claim 10, wherein the controller changes a display state of an icon corresponding to the application converted to the disabled state to be displayable on the display unit.

12. The mobile terminal of claim 11, wherein the controller controls the display unit such that the icon corresponding to the application converted into the disabled state cannot be displayed on the display unit.

13. The mobile terminal of claim 1, wherein the setting screen displays a plurality of items corresponding to a plurality of pre-installed applications, and
wherein one area of an item corresponding to an application converted into the disabled state, among the plurality of applications, is used to display state information relating to the application converted into the disabled state.

14. The mobile terminal of claim 13, wherein the controller maintains the arrangement sequence of the plurality of applications, irrespective of at least one of the plurality of applications being converted into the disabled state.

15. The mobile terminal of claim 1, wherein the selection of the function executable by the application in the disabled state is allowed by an application different from the application in the disabled state.

16. The mobile terminal of claim 15, wherein the controller continuously displays a first function icon corresponding to the function executable by the application in the disabled state on an execution screen of an other application, irrespective of the disabled state of the application when the function executable by the application in the disabled state is cooperative with the other application.

17. The mobile terminal of claim 16, wherein the controller displays the first function icon in a different manner than displaying the first function icon displayed when the application is in the enabled state, such that a user can identify the state of the application.

18. A control method for a mobile terminal comprising:
outputting a setting screen for changing an enabled state of an application;
converting a state of the application from the enabled state into a disabled state to prohibit a user's access to the application based on a control command for disabling the application, the control command being received through the setting screen; and
outputting a pop-up window for changing the disabled state of the application in response to selection of a function executable by the application in the disabled state.

19. The method of claim 18, wherein the function is executed through the application converted into the enabled state as the application is converted from the disabled state to the enabled state.

20. The method of claim 18, wherein the function is executed using an other application, without outputting the pop-up window, when there is the other application for substituting for the application in the disabled state allowing for execution of the function.
